(19) United States
(12) Patent Application Publication
(10) Pub. No.: US 2026/0343248 A1
(43) Pub. Date: Oct. 29, 2026

(54) MOBILITY AWARE REINFORCEMENT LEARNING FOR OPTIMIZING RADIO ACCESS NETWORKS

(71) Applicant: Telefonaktiebolaget LM Ericsson (publ), Stockholm (SE)

(72) Inventors: Maxime BOUTON, Stockholm (SE); Nathali BARRERA, Palo Alto, CA (US); Hasan FAROOQ, Santa Clara, CA (US); Julien FORGEAT, San Jose, CA (US); Shruti BOTHE, Santa Clara, CA (US)

(73) Assignee: Telefonaktiebolaget LM Ericsson (publ), Stockholm (SE)

(21) Appl. No.: 19/103,884

(22) PCT Filed: Aug. 16, 2022
(86) PCT No.: PCT/IB2022/057681

§ 371 Date: Feb. 14, 2025

(51) Int. Cl. H04W 24/02; G06N 3/092; H04W 36/32; H04W 84/04

(52) U.S. Cl. CPC H04W 24/02; G06N 3/092; H04W 36/324; H04W 84/042

(57) ABSTRACT

A computer-implemented method for optimizing resources in a radio access network based on mobility is provided. The method includes obtaining a topology of a radio access network (RAN), the topology comprising a plurality of network nodes serving one or more cells. The method includes obtaining a mobility pattern of a plurality of user equipment (UEs). The method includes initializing a simulation of movement of the plurality of UEs within the topology, wherein the plurality of UEs are initialized in locations in the topology and the UE locations are updated each timestep of a plurality of timesteps of the simulation according to the mobility pattern. The method includes computing, at a first timestep of the simulation, a respective action for each network node of the plurality of network nodes according to a policy. The method includes computing, for each network node of the plurality of network nodes, a reward value based on the mobility pattern and the respective action for each network node. The method includes updating the policy based on the reward value.

### TECHNICAL FIELD

Disclosed are embodiments related to multi-agent reinforcement learning (“RL”), distributed optimization, self-organizing networks (“SONs”), zero-touch automation, and mobility simulation for optimizing radio access networks.

### INTRODUCTION

Users' quality of experience (“QoE”) in cellular networks highly depends on the configuration parameters of the base stations (“BSs”), especially in dynamic user mobility scenarios. Incorrectly tuned BSs could interfere with neighboring antennas and deteriorate the signal of users moving through sectors that would otherwise have good coverage. In [1] (“Bouton”), PCT/IB2020/061668, “Decentralized coordinated reinforcement learning for optimizing radio access networks,” filed on Dec. 9, 2020, and hereby incorporated by reference in its entirety, coordinated and distributed reinforcement learning was applied to the problem of antenna tuning optimization.

Traditional optimization methods of adjusting the antenna tilt are done through expert experience, drive tests, and manual tuning. To appropriately configure a network before deployment, engineers must anticipate many possible traffic conditions, mobility scenarios, as well as possible sources of interference from the environment and the network itself. One method of optimizing the network before deployment is to perform drive tests around common mobility patterns in heavily trafficked areas. These different areas will amount to different mobility patterns of user equipments (“UEs”) at different times of the day, resulting in hot zones and dead zones [2], which are areas where there is high UE traffic, and areas where there is no network coverage, respectively. It is highly likely, however, that the propagation conditions, the traffic distribution, or even the location of the base station would change between the planning and deployment phase due to unforeseen events. As a consequence, it is important that networks have the ability to be optimized and dynamically re-configured during and post deployment time. With a constantly growing demand in high-quality services, increasing network complexity, and highly dynamic environments, relying on human interventions to update network configurations leads to a suboptimal use of the network resources and is often very costly.

Instead, one could automate the optimization procedure under the context of Self-Organizing Networks (SONs) [3]. The SON framework allows to perform capacity and coverage optimization by tuning the parameters of the base stations to improve the network performance. Commonly used parameters for self-optimizing networks are hardware parameters such as antenna tilt (electrical and mechanical), azimuth and transmission power, but also software parameters such as Cell Individual Offset (CIO).

Choosing these parameters normally requires extensive domain knowledge. To automate the procedure, one must iteratively define a control strategy mapping measurements from the network (e.g., signal strength received by the users) to a base station configuration, and then sequentially apply this new configuration. While the location of the base stations cannot be changed, modifying the base stations configuration online to adapt to various traffic conditions such as moving hot zones and dead zones, decrease or increase of UE traffic during certain times of day, and base station handovers can greatly improve the QoE. Approaches for automating antenna tuning can be divided in three categories: hand-engineered rule-based methods [3,4,5,6], optimization methods, [7] and reinforcement learning based methods [8, 9, 10, 11, 12, 13]. These methods all fall under the broader category of SONs [3]. Reinforcement learning has many advantages over heuristics and optimization methods.

Reinforcement learning methods have been used to address the problem of dynamically tuning antennas in cellular networks [8, 10, 11, 13, 14]. Most of these approaches rely on fully independent agents at each base station and consider static snapshots of the network in a moment in time [8, 13, 14].

A coordinated reinforcement learning method has been applied to the problem of optimizing base stations parameters in cellular networks using antenna tilt [1]. The network uses a coordination graph to apply a distributed algorithm in the goal of finding a globally optimal joint antenna configuration. The optimization procedure is combined with local reinforcement learning updates in accordance with the cellular network topology [1].

Realistic modeling of mobility behavior has been proposed to do a performance evaluation in a mobile ad hoc network [15]. This method presents a comparative simulation of Random Waypoint and Gauss-Markov mobility models and is used with a routing protocol to evaluate the performance of the ad-hoc mobility network.

Reinforcement learning in a mobility aware network has been proposed to do joint task offloading and migration schemes in a mobility-aware Mobile Edge Computing network with reinforcement learning to maximize system revenue [16]. To create the mobility model, the exponential function of sojourn time, the time spent by mobile users in a given cell, is used to measure the mobility of mobile equipment.

Deep learning may be used to extract the features by learning the locations of users and, uses multi agent mean field reinforcement learning to learn the average interference values for different antenna settings. This location aware control does not account for user movement within the network, and instead considers a known static location when using the multi-agent algorithm.

The down-tilt of base-station antennas may be adjusted to maximize the user throughput fairness and power efficiency [14]. A distributed reinforcement learning algorithm is introduced where base stations don't use the location data of the users. The algorithm achieves convergence to a near optimal solution improving the throughput fairness and energy efficiency compared to fixed strategies [14].

Real world data measurements can be time consuming and lack a controllable environment. This large system complexity can result in network simulations that are significantly different than real world observations. Network performance evaluations can be done using simulations, however necessary simplifications and many configurations can achieve results that differ from real world behavior. One method presents a data-driven approach where different machine learning models are combined to represent the analyzed system behavior where the method is evaluated against field measurements and network simulation [17].

One work explores the goal of increasing network coverage and improving robustness in dead zones where there is no network coverage [18]. The method includes location management, connection management and route reconfiguration, where location management maintains the location information for mobile stations. An approach is proposed for micro-mobility management in heterogeneous multi-hop networks, and a connection and multi-hop route configuration scheme for increasing network coverage and capacity [18].

### SUMMARY

Reinforcement learning approaches offer a principled way to update the tuning strategy online by learning from the stream of data coming to the different base stations. However, most reinforcement learning methods applied to antenna tuning, including those described above, fail to consider dynamic mobility patterns resulting from the movement of the UEs between the base stations. Instead, prior approaches consider users as static entities and do not emulate movement patterns that might happen in very dense networks that are expected to be deployed [8,10].

Aspects of the present disclosure include an algorithm agnostic mobility-aware reinforcement learning method for dynamic antenna parameter configuration that takes into account network parameters between base stations and the frequent movement of users. Aspects of the present disclosure use the option of including real network mobility data as well as the ability to generate custom mobility simulation data so that the model can achieve a better representation of network behavior to use with the optimization problem. The reinforcement learning method may be used with simulated data from three different mobility patterns for realistic movement scenarios: working professional commute, random waypoint, and Gaussian Markov. The patterns may be optional and meant to train the algorithm for robustness in its optimization. This method also allows for external mobility patterns to be used to train the algorithm using deployments in production. Additionally, the reward function of the reinforcement learning algorithm considers multiple mobility-relevant optimization strategies. In some embodiments, the baseline average throughput reward, edge SINR reward and power consumption reward are compared with UE flow penalty to formulate the best learning results.

Aspects of the proposed method including training a reinforcement learning agent in simulation. The method may rely on the concept of reinforcement learning used with mobility simulation and a network performance reward function to model a dynamic UE environment. Accordingly, aspects of the proposed method adapt user mobility simulation to the problem of optimizing base station parameters in cellular networks. Real-world network simulation scenarios with user mobility may lead to more optimal control strategies than previous attempts to apply RL to similar problems.

By representing the cellular network using different user mobility schemes, a reinforcement learning algorithm may be used to find a globally optimal joint antenna configuration. To capitalize on the mobility simulation, mobility-relevant network performance calculations are used to supplement local reinforcement learning updates in a way that takes advantage of the cellular network scenario. The proposed methods may be used with any reinforcement learning algorithm and using any external sources of mobility patterns. Aspects of the present disclosure provide the flexibility to scale the use case using any RL algorithm, a way to use this method with input data from real or simulated scenarios, along with a principled way to perform mobility-aware network optimization.

According to one aspect, a computer-implemented method for optimizing resources in a radio access network based on mobility is provided. The method includes obtaining a topology of a radio access network (RAN), the topology comprising a plurality of network nodes serving one or more cells. The method includes obtaining a mobility pattern of a plurality of user equipment (UEs). The method includes initializing a simulation of movement of the plurality of UEs within the topology, wherein the plurality of UEs are initialized in locations in the topology and the UE locations are updated each timestep of a plurality of timesteps of the simulation according to the mobility pattern. The method includes computing, at a first timestep of the simulation, a respective action for each network node of the plurality of network nodes according to a policy. The method includes computing, for each network node of the plurality of network nodes, a reward value based on the mobility pattern and the respective action for each network node. The method includes updating the policy based on the reward value.

In some embodiments, the method further includes assigning, at the first timestep of the simulation, a set of one or more coordinates of the topology as a hot zone based on the mobility pattern.

In some embodiments, the method further includes selecting a set of UEs from the plurality of UEs and calculating, at the first timestep of the simulation, one or more key performance indicator (KPI) of each UE in the set of UEs. In some embodiments, the KPI is at least one of: signal to interference plus noise ratio (SINR), throughput, or power consumption.

In some embodiments, the mobility pattern comprises a mobility model comprising Working Professional, Random Waypoint, Gaussian Markov, a custom mobility pattern, or a combination thereof. In some embodiments, the Working Professional mobility model simulates an individual movement pattern of a UE belonging to a commuting professional who moves between an office and a home location during one or more intervals of time. In some embodiments, the Random Waypoint mobility model creates random movement simulation for each UE and how the UE's location, velocity, or acceleration changes over time.

In some embodiments, the Gaussian Markov mobility model creates movement across the topology where a UE's next transition point depends on the UE's speed or direction at a current timestep. In some embodiments, a UE's speed and direction at a previous timestep is related to the UE's speed and direction at a current timestep according to: sₙ=αsₙ₋₁+(1−α)s̅+(1−α²){square root over (s_{χ}_{_{n−1}})} and dₙ=αdₙ₁+(1−α)d̅+(1−α²){square root over (d_{χ}_{_{n−1}})}, wherein sₙ and dₙ are the UE's values of speed and direction of movement in current timestep n, sₙ₋₁ and dₙ₋₁ are the UE's values of speed and direction of movement in the previous timestep n−1, α is a tuning parameter with a constant value with the range [0,1] which represents a different degree of randomness, s̅ and d̅ are constants which represent a mean speed and direction, and s_{χ}_{_{n−1}} and d_{χ}_{_{n−1}} are variables sampled from a random Gaussian distribution parameterized by their mean and their variance.

In some embodiments, the custom mobility pattern model comprises a dataset comprising a UE's trajectories at a regular interval or a mobility model that takes as input a set of user locations in the topology at an initial timestep and outputs a second set of user locations in the topology at a next timestep.

In some embodiments, the computing, at the first timestep of the simulation, the respective action for each network node of the plurality of network nodes comprises calculating aᵢ=μ(sᵢ;θ) for all network nodes i, where αᵢ is the action of network node i, μ is the policy, sᵢ is a mobility state at a timestep in the simulation, and θ represents parameters of a learned policy. In some embodiments, θ represents a set of one or more weights for a neural network.

In some embodiments, the reward value R(s,a,s′) is computed according to R(s,a,s′)=R_{static}(a,s′)+wR_{mobility}(s,a,s′), wherein s is a mobility state at a current timestep of the simulation, a is the computed action, and s′ is a mobility state at a next timestep of the simulation, R_{static} is a reward for a static network performance, w is a weight, and R_{mobility} is a reward for a mobility network performance corresponding to state s at a current timestep of the simulation, action a, and state s′ at a next timestep of the simulation. In some embodiments, R_{mobility} corresponds to a reward proportional to an average throughput, a signal to interference plus noise ratio (SINR) fairness, an edge SINR, a power consumption, a UE flow, or a combination thereof. In some embodiments, the average throughput comprises an average of each UE throughput in a sector of each network node. In some embodiments, the average throughput further comprises normalizing the average of each UE throughput by subtracting a mean throughput and dividing by a maximum throughput. In some embodiments, the SINR fairness F is calculated according to

$$F = \frac{{S}_{5 \%}}{{S}_{avg}} ,$$

wherein S_{5%} corresponds to cell-edge UE SINR in a bottom 5% of SINR values, and S_{avg} corresponds to a mean UE SINR in a given cell. In some embodiments, the edge SINR is proportional to a cell-edge UE SINR comprising a bottom 5% of SINR values. In some embodiments, the power consumption is a penalization corresponding to a total transmit power over an average UE throughput per a cell sector. In some embodiments, the UE flow UE_{flow} is a penalization calculated according to:

$${UE}_{flow} = \frac{\vert \# UE ( {s}^{′} ) - \# UE ( s ) \vert}{\# UE ( s )} ,$$

wherein #UE(s′) is a number of UEs in a mobility state at a next timestep s′ and #UE(s) is a number of UEs in a mobility state at a current timestep s. In some embodiments, R_{mobility} is a penalization having a negative value.

In some embodiments, the policy comprises a reinforcement learning (RL) model.

In some embodiments, the topology comprises a Cartesian plane having a boundary, and coordinates of each network node and their respective cell identifier(s) are plotted in the Cartesian plane.

In some embodiments, the action comprises a tilt of an antenna of each respective network node.

In another aspect there is provided a device with processing circuitry adapted to perform the methods described above. In another aspect there is provided a computer program comprising instructions which when executed by processing circuitry of a device causes the device to perform the methods described above. In another aspect there is provided a carrier containing the computer program, where the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a radio access network, according to some embodiments.

FIG. 2 illustrates a mobility scenario in a radio access network, according to some embodiments.

FIG. 3 illustrates interaction between a base station and its serving sector in a radio access network, according to some embodiments.

FIG. 4 illustrates a method, according to some embodiments.

FIG. 5 illustrates a movement pattern of three user equipment according to a Working Professional mobility pattern, according to some embodiments.

FIG. 6 illustrates a movement pattern of three user equipment according to a Random Waypoint mobility pattern, according to some embodiments.

FIG. 7 illustrates a movement pattern of three user equipment according to a Gaussian Markov mobility pattern, according to some embodiments.

FIG. 8 illustrates a Gaussian Markov pareto graph showing different reward functions against SINR performance, according to some embodiments.

FIG. 9 illustrates a method, according to some embodiments.

FIG. 10 illustrates a block diagram of a device, according to some embodiments.

### DETAILED DESCRIPTION

Aspects of the present disclosure include a mobility simulation from production networks and/or UE movement pattern simulations to generate realistic network data for training RL agents. The reward function of the RL algorithm may be formulated for network performance calculations, such as average throughput, edge SINR, and/or power consumption, with a penalty for UE flow for mobility-aware model training. Additionally, the algorithm agnostic problem modeling supports various RL algorithms to provide flexibility and scalability.

Aspects of the present disclosure outperform existing technologies in at least the following aspects.

Mobility-aware UE simulation: production of three UE mobility patterns combined with a network simulator to generate realistic cellular network data. These patterns are produced in a 24-hour period to model a full day of UE hot-zone movement for the RL algorithm to account for in its training. The method also allows for custom mobility coordinates input where the user can assign external mobility patterns to train the model. Including this mobility in the problem formulation allows the model to be more resilient towards changes in mobility scenarios and to learn strategies to update network configurations.

Dynamic network performance reward function: the reward function of the RL algorithm includes calculations of mobility relevant KPIs along with Edge SINR and Power Consumption. This reward function includes UE flow penalty, which penalizes the system for increased UE handover. The network performance is shown to outperform standard RL algorithm relying on the Average Throughput in the reward.

An algorithm agnostic problem modeling which supports various RL algorithms including state-of-the-art multi-agent RL with coordination between the base stations. This provides flexibility in choosing the right RL algorithm for the chosen network scenario.

The problem of optimizing network performance may be modeled by combining mobility simulation and network simulation data into a reinforcement learning process. The experiments conducted correspond to optimizing the antenna tilt parameter, however the methods proposed are applicable to any network parameters.

The individual action space of each base station corresponds to a set of possible configurations, such as, for example, tilt values, azimuth values, power, and so forth. Any remotely controllable antenna parameter could be used as the action space. In experiments described later herein, a continuous range of electrical down tilt values from 0° to 16° was used.

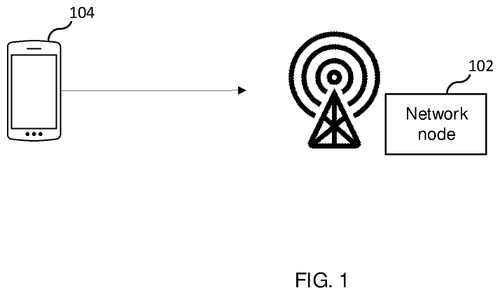

FIG. 1 illustrates a radio access network (100), according to some embodiments. The RAN may include a network node (102), which may optionally be serving a UE (104). While only one network node (102) and UE (104) are shown in FIG. 1 for simplicity, a person of skill would understand that the RAN (100) may include many UEs and network nodes.

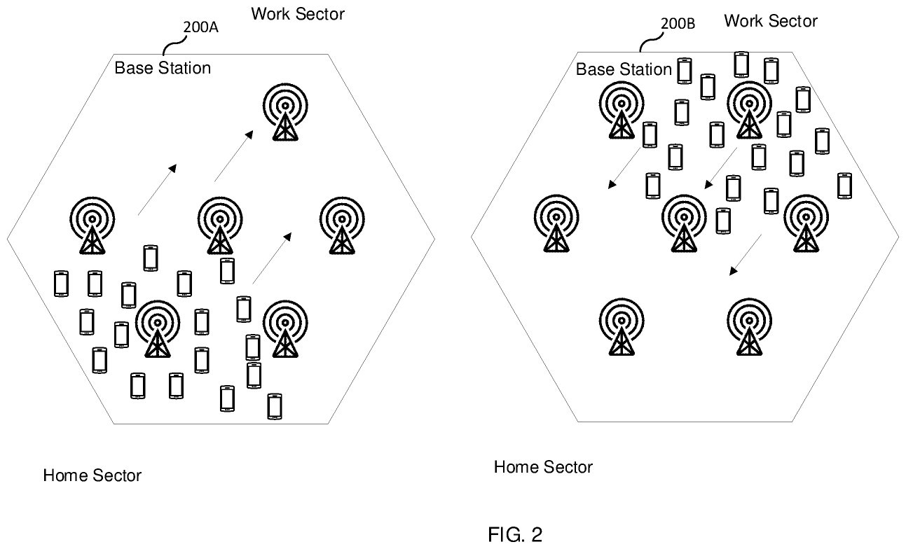

FIG. 2 illustrates a mobility scenario in a radio access network, according to some embodiments. Aspects of the present disclosure consider the environment (e.g., RAN 200A-B) as dynamic, represented by a user distribution that changes according to different mobility patterns. Multiple hot zones may be defined on the map, and a number of UEs (e.g., 10,000) are then sampled randomly with a greater probability of being in a hot zone. During the simulation, hot zones move according to the given mobility model and UEs are resampled in the new hot zone location at every timestep. FIG. 2 illustrates a simple rendering of a mobility simulation scenario moving through the sectors in the network environment, such as where UEs move from a home sector to a work sector. In FIG. 2, the “Working Professional” scenario is modeled, describing the work-home commute pattern in a 24-hour period.

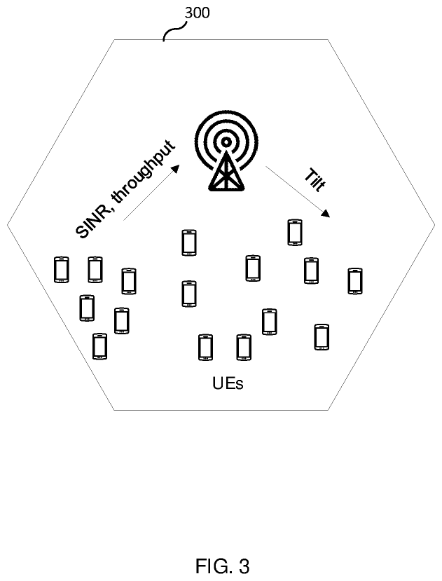

FIG. 3 illustrates interaction between a base station and its serving sector in a radio access network 300, according to some embodiments. Each base station can observe various performance indicators from the network such as the SINR, Reference Signal Received Power (RSRP), channel quality indicator (CQI) of each UE connected to it. This information can be processed and used as a state input to the reinforcement learning policy. FIG. 3 illustrates the local interaction loop happening between a base station and its serving sectors.

According to some embodiments, each agent is collaborating to improve the quality of the overall network. Examples of objectives include average SINR, number of UEs with SINR above a certain threshold, among many more objectives. This global objective is distributed into individual rewards at the sector level such that each agent receives a reward about its local performance. In the reward formulation, two different calculations may be proposed to determine performance of the network with a given antenna tilt angle, Edge SINR and Power Consumption. First, an Average Throughput reward calculation may be used as a baseline network performance measurement. Second, within the reward formulation, a UE flow penalty may be included which will help the system learn to minimize UE handover between cells.

One example goal of the techniques disclosed herein is to find a joint antenna configuration that maximizes the global network performance while considering UE mobility and local network measurements. As shown in FIG. 3, the base station collects measurements from the UEs, and a tilt configuration is selected which in turns affects the UEs. This illustration shows only one base station, but the techniques disclosed herein may further relate to interaction between multiple base stations and antennas, such as shown in FIG. 2.

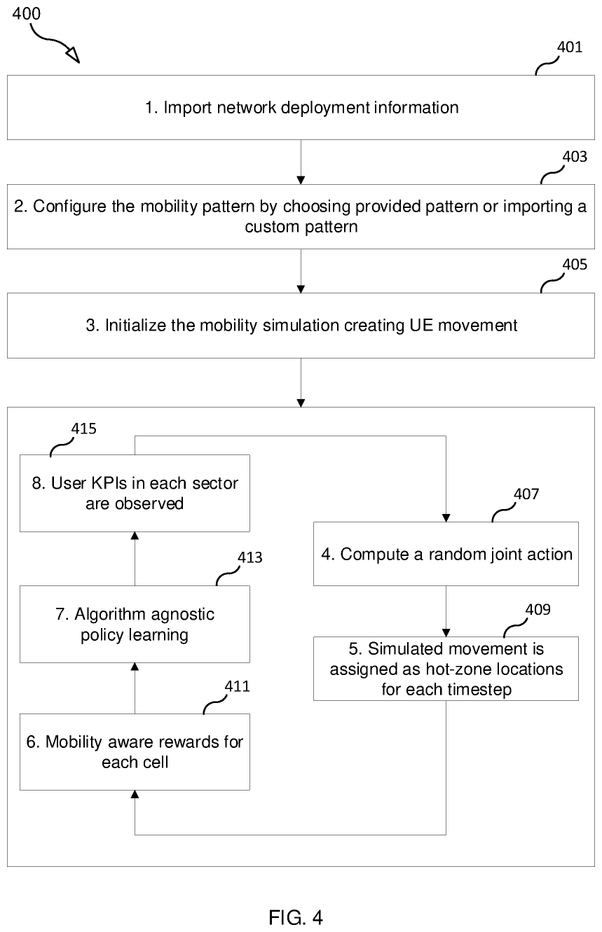

FIG. 4 illustrates a method, according to some embodiments. According to some embodiments, method 400 is a mobility-aware reinforcement algorithm for network optimization.

Steps 401 and 403 initialize a mobility simulation scenario by importing the location and identifiers of the base stations to create the topology and generate the UE locations.

Step 401 includes creating a simulation topology using the imported network deployment information. In some embodiments, to simulate the mobile network, a topology of network nodes (e.g., EnodeBs) is created. The topology may include a Cartesian plane describing a boundary for simulation, and UE's mobility within the simulation plane is defined. The coordinates of the network nodes and their cell identifiers are imported and plotted in the topology, while using the max x and y coordinates to define the size of the plane where the simulation is run.

Step 403 includes choosing a provided mobility pattern or importing a custom mobility pattern. In some embodiments, the mobility scenario can be modeled using three different mobility algorithms: Working Professional, Random Waypoint, and Gaussian Markov. These movement patterns are designed to describe the movement patterns of UEs and how their movement changes over time. Necessary parameters to build the network may include defining the number of UE's and defining constraints to apply to the simulation. An important aspect in a simulation study may be for the mobility pattern to reflect the real behavior of UE movement, and be robust enough to handle non-uniform patterns in order to reflect the effects of certain mobility scenarios. Having the Working Professional pattern to simulate traffic conditions in customizable scenarios provides a method of learning from a realistic uniform pattern, while the Random Waypoint and Gaussian Markov patterns help enhance the model's performance in a highly complex network.

The Random Waypoint model is a useful method of mobility simulation as it will create a simple random speed and direction movement every timestep, which can create sharp turns and sudden stops in its pattern, which can simulate UEs coming in and out of the network. Gaussian Markov mobility patterns show a smoother trajectory where the speed and direction of the UE is modeled depending on the previous timesteps speed and direction.

In some embodiments, input of real mobility data from a network is used to generate mobility simulations. By having the ability to use generated simulation scenarios or production network data, the method may allow the model to be more resilient towards the behavior of real-world scenarios.

### Working Professional Mobility Pattern.

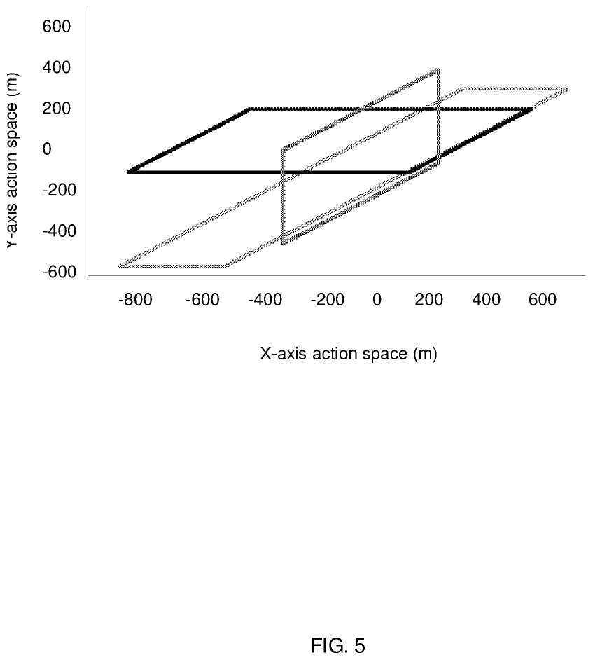

FIG. 5 illustrates a movement pattern of three user equipment according to a Working Professional mobility pattern, according to some embodiments. The pattern describes different users starting from the “home sector,” traveling to the “work sector” and then traveling back to the starting point. The Working Professional mobility model may simulate the individual movement pattern of a UE belonging to a commuting professional who moves between their office and home during certain intervals of time. In one example, the full simulation takes 1440 timesteps, the equivalent number of minutes in a 24-hour period, and demonstrates the user moving to the office from home in the daytime, staying at work for a period of time, and then during the evening moving back to the initial home location. The initial coordinates defining the home and office location may be randomly selected unless defined by constraints. As each timestep changes, the UE would follow a customized algorithm to allow for its next position transition. This mobility pattern includes constraints where the home and office coordinates can be sampled from a sub-grid of the mobility plane. Speed of the UEs is also another possible constraint within this mobility pattern.

### Random Waypoint Mobility Pattern.

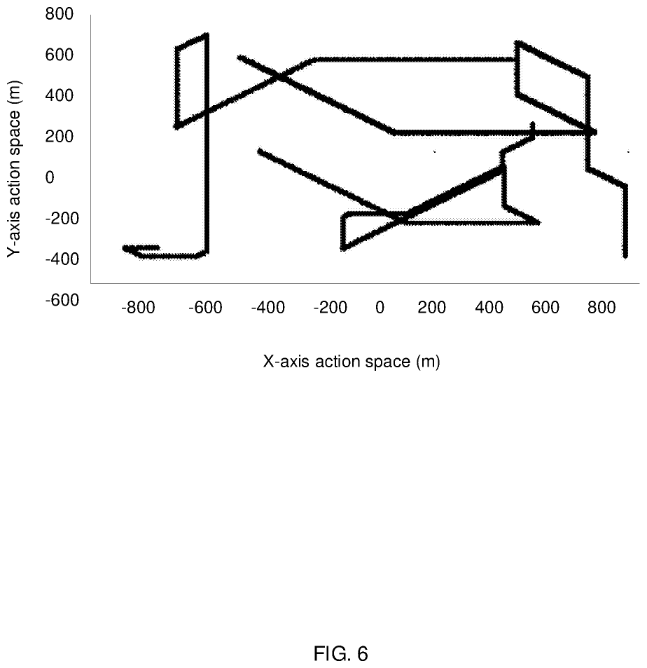

FIG. 6 illustrates a movement pattern of three user equipment according to a Random Waypoint mobility pattern, according to some embodiments. The Random Waypoint Mobility model may create random movement simulation for the UE, as well as how the UE's location, velocity and acceleration change over time. The UE moves randomly without restrictions, with its destination, speed and direction all chosen randomly and independently of other UEs. The movement pattern is controlled by allowing the UE to move or pause for a timestep based on a probability for movement. Subsequently the UE selects a random destination in the simulation area with a random minimum speed and maximum speed at every timestep. Once the UE moves to this destination, another random location, minimum and maximum speed will be chosen as its next movement. The behavior is then repeated for the given number of timesteps. This movement pattern includes constraints like speed and UE movement probability, where at each timestep the UE calls on a function to move or not to move, deciding based on this parameter of probability from 0 to 1.

### Gaussian Markov Mobility Pattern.

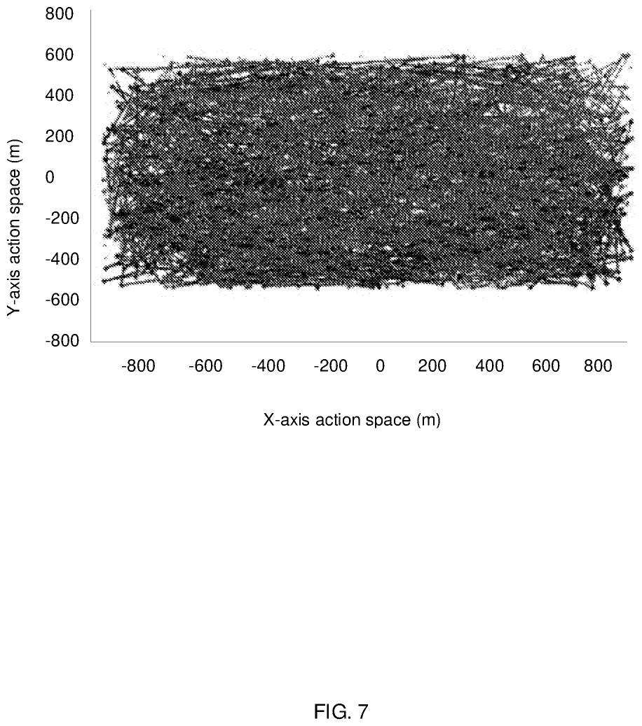

FIG. 7 illustrates a movement pattern of three user equipment according to a Gaussian Markov mobility pattern, according to some embodiments. The Gaussian Markov Mobility model may create movement across the simulation plane where the UEs next transition point depends on the UEs' speed and direction at the current timestep. The current speed and direction are related to the previous speed and direction with the following equations (1) and (2):

sₙ=αsₙ₋₁+(1−α)s̅+(1−α²){square root over (s_{χ}_{_{n−1}})} (1)

dₙ=αdₙ₋₁+(1−α)d̅+(1−α²){square root over (d_{χ}_{_{n−1}})} (2)

In equations (1) and (2) above, sₙ and dₙ are the values of speed and direction of movement in timestep n. sₙ₋₁ and dₙ₋₁ are the values of speed and direction of movement in the timestep n−1. α is a tuning parameter with a constant value with the range [0,1] which represents the different degrees of randomness. s̅ and d̅ are constants which represent the mean speed and direction, and s_{χ}_{_{n−1}} and d_{χ}_{_{n−1}} are variables sampled from a random Gaussian distribution parameterized by their mean and their variance.

Alpha, the UE move probability, the initial speed, initial direction, mean speed and the mean direction along with the mean and variance of the Gaussian distribution used to draw s_{χ}_{_{n−1}} and d_{χ}_{_{n−1}} are constraints that can be defined in the mobility simulation.

### Custom Mobility Pattern.

In some embodiments, a custom mobility pattern may be imported into the training procedure in addition to any one of the three patterns described above. In some embodiments, the custom mobility pattern can take two forms. (1) Dataset: a dataset consisting of user trajectories at regular interval. For example, each column of the dataset corresponds to one user or one hot zone, each row corresponds to one time step. One entry in the dataset is the location of the user or hot zone in the map associated with the imported deployment. (2) Mobility model: a mobility model could be software that can be called during the next time step. The model takes as input a set of user locations in the given map and outputs the user locations at the next time step. The time step does not have to be known by the mobility model.

Returning back to FIG. 4, Step 405 initializes the mobility simulation, creating UE movement. In some embodiments, the network is initialized randomly where the UEs are placed in random locations and move according to the specified mobility pattern and constraints. In some embodiments, the mobility simulation runs for a full day, or a certain number of timesteps (e.g., 1440 timesteps if each timestep is 1 minute in duration) to run a complete mobility scenario and logs all relevant movement data, including the series of coordinates, ID, direction, speed, and static probability distribution for transition. The mobility data used from this simulation method is the timesteps and the corresponding coordinates of each UE. The time period for running the mobility simulation and the time period for each timestep may be flexible and is not limited to one day or a specific certain number of timesteps.

Steps 407-415 correspond to an interaction in reinforcement learning, where each agent (e.g., network node) gathers an experience tuple

$$( {s}_{i} , {a}_{i} , {r}_{i} , {s}_{i}^{′} ) ,$$

where sᵢ′ is the state observed after applying configuration aᵢ and after stepping through the mobility model for one step.

Step 407 includes computing a random joint action. This step consists of taking an action and collecting data. An action for each base station/agent will be taken according to the RL algorithm being used. The action can follow an exploration strategy such as ϵ-greedy or softmax. For example, using the DDPG algorithm [20]: aᵢ=μ(sᵢ;θ) for all agents i, where μ is the policy learned by the algorithm, and θ represents the parameters of the learned policy (e.g., neural networks weights). They can be shared across agents. In one embodiment, the action in the problem may be an antenna tilt change with inputs ranging from 0° to 15°.

Step 409 includes assigning simulated movement as hot-zone locations in each timestep. Mobility simulation data is used by the training environment to generate the mobility-aware space for the RL algorithm. Since this problem is mobility aware, the environment has a dynamic UE distribution. The state for this problem is continuously changing as per the UE positions mobility. The logged mobility data is iterated through for each timestep, and its coordinates are assigned to hot zones in a network simulator. For example, a circular hot zone may be defined by its radius and its center position, the latter of which is defined by the coordinates from the simulation.

Step 411 includes calculating mobility-aware rewards for each cell. After the agent takes this action, it receives a reward from the environment. The reward signal can comprise of any performance indicator measurable by a base station such as the average SINR, the number of UEs with SINR greater than a threshold, the average throughput or the 10th percentile throughput or SINR for example.

In some embodiments, the reward design consists of two terms, one responsible for static network performance (R_{static}) and one related to mobility (R_{mobility}), and a tunable weight to the mobility component may be introduced as follows: R(s,a,s′)=R_{static}(a,s′)+wR_{mobility}(s,a,s′). As described below, different techniques may be used to compute each component and tune the weight w.

### Reward Function Modifications for Mobility Aware Reinforcement Learning

In some embodiments, each antenna receives a reward proportional to the Edge SINR, Power Efficiency, and Average Throughput calculations in its sector. Several reward functions may be proposed to enable the agent to learn the optimal policy to decide the action based on the state at each time step. The method proposed attempts to maximize the accumulated reward over time. Definitions for different example reward functions are listed below. Each reward is noted as proportional to because different normalization techniques may be used to numerically condition the reward for better learning performance. Normalization involves subtracting by a constant and dividing by a constant. Table 1 below lists several parameters and their corresponding symbol.

TABLE 1

| Parameter | Symbol |
|---|---|
| BS Transmit Power | P_{BS} |
| Cell-edge SINR | S_{5%,} |
| SINR Per User | S |
| Cell-avg SINR | S_{avg} |
| Cell-max UE SINR | Sₘₐₓ |
| Cell-min UE SINR | Sₘᵢₙ |
| Cell-mean UE | TH |
| Throughput | |
| Cell-max UE | THₘₐₓ |
| Throughput | |
| Cell-min UE Throughput | THₘᵢₙ |
| UE Throughput Per | TH_{avg} |
| Sector | |
| Reward Function | R(s, a, s′) |
| Non mobility aware | R_{static}(s′, a) |
| reward component | |
| UE flow at current | UE_{flow}(s, a, s′) |
| timestep | |
| Weight | w |

### Average Throughput

The average throughput of a cell is defined by average of each individual UE throughput in the same sector. The sector throughput is the defined as the average throughput of the UEs within the sector of each base station. The average throughput may be normalized by subtracting the mean throughput and dividing by the maximum throughput. The mean and maximum throughputs are constants that are approximately evaluated before training by running random simulations. The static reward is given by R_{static}∝TH_{avg}.

### SINR Fairness

The UEs in each base station may have a fairness index defined in previous works, such as [14]. It corresponds to the ratio of the cell-edge UE SINR which is the bottom 5% of the SINR values, and the cell-mean UE SINR in a given cell. This reward definition may be challenging for an RL agent as maximizing this reward can be achieved through lowering the average SINR which is an undesirable behavior:

$${R}_{static} ∝ \frac{{S}_{5 \%}}{{S}_{avg}}$$

### Edge SINR

In some embodiments, the following edge SINR performance metric may be more suitable for RL tasks than previous metrics. In some embodiments, the reward is proportional to the Edge 5% SINR. The reward may be divided by a constant value corresponding to the maximum SINR measured empirically in order to rescale the reward: R_{static}∝S_{5%}.

### Power Consumption

In some embodiments, the following power consumption metric may be more suitable for RL tasks than previous metrics. Total power consumption may be the total transmit power over the average UE throughput per sector. Because the objective may typically be to minimize the power consumption, a minus sign is added in order to define a reward that can be maximized:

$${R}_{static} ∝ - \frac{{P}_{BS}}{{TH}_{avg}}$$

The power consumption may be normalized by dividing by a constant corresponding to the maximum power consumption evaluated through random simulations prior to training. Note that this reward definition may also be useful in cases where P_{BS} is controlled by the RL agent.

### UE Flow

In some embodiments, the reward functions may be penalized with UE flow, described in the following equation: R(s,a,s′)=R_{static}(s′,a)−wUE_{flow}(s,a,s′).

The UE flow metric may be calculated by subtracting the current number of UEs in each sector from the next number of UEs in that sector, normalized by the current number of UEs in that sector:

$${UE}_{flow} = \frac{\vert \# UE ( {s}^{′} ) - \# UE ( s ) \vert}{\# UE ( s )}$$

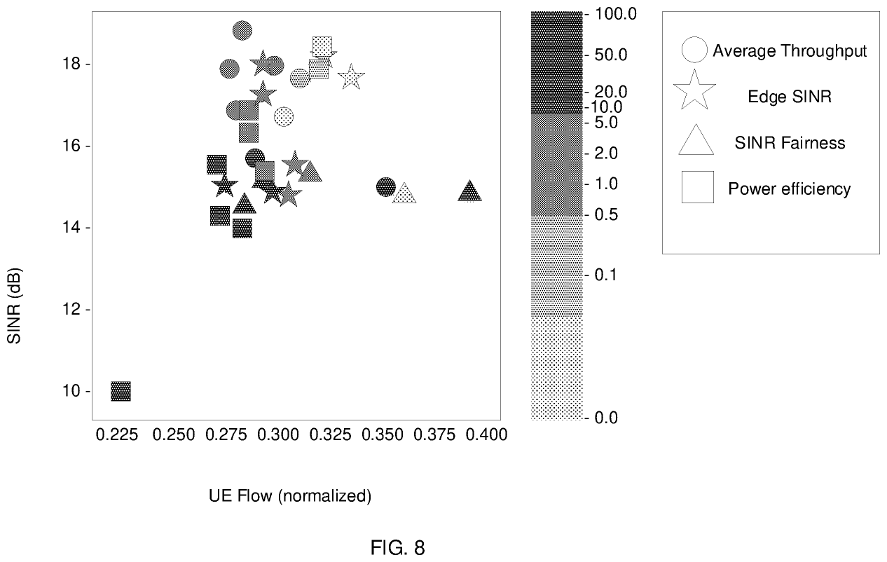

It reflects the number of cell reselection in one time step. This value receives a certain weight depending on which mobility pattern was used. The weight is useful to tune how much mobility should be prioritized by the reinforcement learning agent. Automated hyperparameter search techniques can be used to tune w or by the construction of a Pareto graph as illustrated in FIG. 8.

FIG. 8 illustrates a Gaussian Markov pareto graph showing different reward functions against SINR performance, according to some embodiments. The Pareto graph may use different colors (indicated in FIG. 8 as concentrations of speckling) for each reward function symbol to reflect different weight values to help determine which weight value is most optimal for the given mobility pattern. There are different weight values that are optimal for different mobility patterns, so the graph is meant to support the choice in the right weight value for different reward functions. It illustrates the trade-off between static performance (y axis) and mobility related performance (x axis). As shown in FIG. 8, introducing penalties on mobility can actually improve static performance such as SINR (indicated by medium weight speckling) as compared to no penalties (indicated by low weight speckling). When the penalty is very high an agent can be trained that focuses greatly on optimizing mobility at the expense of static performance (e.g., bottom left corner).

By adding UE flow as a penalty in the reward function, the model attempts to minimize UE flow. According to one example, a minimization of UE flow was observed as the model learned from this penalty using different weight values. In the Gaussian Markov model, higher weights caused lower UE flow. For the random waypoint model, there was no clear correlation between the weight and the final UE flow. This can be explained by the fact that there is no clear mobility pattern to be captured by the learning agent thus the introduction of the mobility weight does not bring strong value. For the Working Professional model, UE flow showed a very narrow range of final values. A few reasons for that can be the predictable pattern of Working Professional mobility, and the lack of movement during the “office working” time in the mobility pattern, such that even with a small penalty the agent can be good at minimizing UE flow.

Returning back to FIG. 4, Step 413 uses a reinforcement learning like Q-learning, DDPG, or Coordinated RL to learn a policy for each agent. The RL algorithm consists of sampling an experience tuple

$$( {s}_{i} , {a}_{i} , {r}_{i} , {s}_{i}^{′} )$$

for every learning agent i, and using a set of equations to update the weights of a policy and/or value function. The experience tuple is collected through the previous steps and can be stored in a replay buffer (off-policy learning) or used directly (on-policy learning).

In some embodiments, the DDPG (Deep Deterministic Policy Gradient) algorithm is used, which uses the following update equations:

$$ϕ ← ϕ + α [ {r}_{i} + γ Q ( {s}_{i}^{′} , μ ( {s}_{i}^{′} ; θ ) ) - Q ( {s}_{i} , {a}_{i} ; θ ) ] {∇}_{ϕ} Q ( {s}_{i} , {a}_{i} )$$

$$θ ← θ + α {∇}_{θ} Q ( {s}_{i} , μ ( {s}_{i} ; θ ) ; ϕ )$$

Where Q is a value function parameterized by φ, μ is a policy parameterized by θ, α is a learning rate. The value function and policy parameters are shared across all agents.

Step 415 includes observing user KPIs in each sector. Because the number of users in a sector can vary, in some embodiments the number of maximum observed UEs is capped to a fixed number. In order to still get a representative sample of the UEs in the cell, the number of UEs are selected at random to observe at the beginning of the episode. Throughout the episode, the same UEs are always observed in the same order for the algorithm to understand UE mobility. Mathematically, the input to a single agent is a vector of the following form:

[x₁,y₁,x₂,y₂, . . . xₙ,yₙ]

Where n is the number of UEs to observe (a hyper parameter of the algorithm), xᵢ and yᵢ represents the position of a UE relative to the cell. In case where the position is not directly observable by the network, it is assumed that the position can be approximated using triangulation techniques. In some embodiments, the position measurements do not need to be accurate because the evolution of the position over time are more important.

For the observation space, the feature information is used to represent the environment from the simulation, it can also be augmented with information like antenna parameters (value of the tilt for example), statistics on the SINR or throughput of the UEs in that sector.

Experiments were run with the three simulated mobility patterns. In the experiments, the Power Efficiency and Edge SINR reward functions lead to better performance in comparison to the Average Throughput and SINR Fairness reward functions in almost every scenario. The metrics measured include SINR (dB), bottom 10% SINR (dB), Throughput (bps) and bottom 10% Throughput (bps). Additionally, the reward functions, Power Efficiency and Edge SINR, achieved a higher performance in a lower number of steps, meaning they are more sample efficient and converge faster than prior techniques.

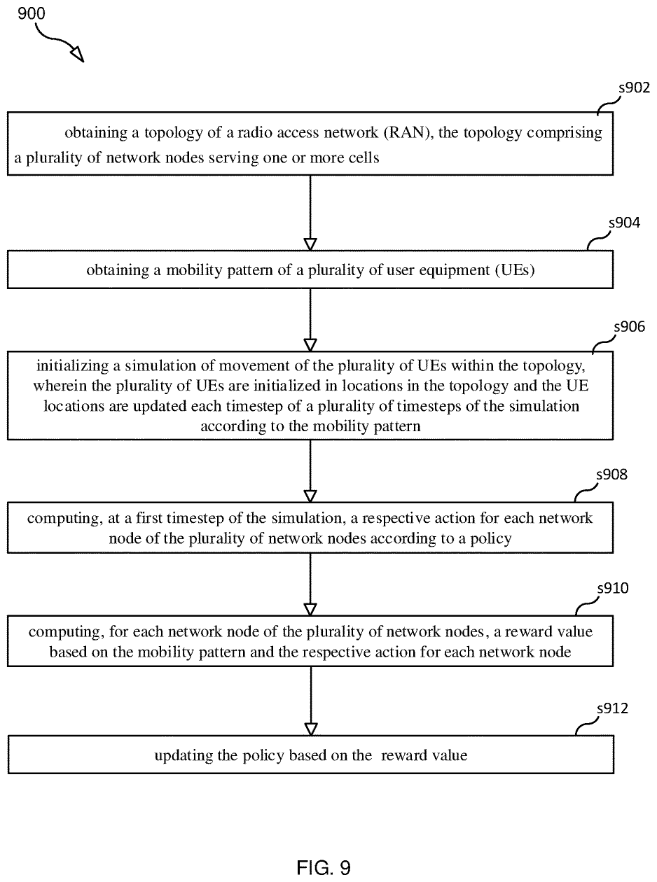

FIG. 9 illustrates a method, according to some embodiments. In some embodiments, method 900 is a computer-implemented method for optimizing resources in a radio access network based on mobility.

Step s902 of the method includes obtaining a topology of a radio access network (RAN), the topology comprising a plurality of network nodes serving one or more cells.

Step s904 of the method includes obtaining a mobility pattern of a plurality of user equipment (UEs).

Step s906 of the method includes initializing a simulation of movement of the plurality of UEs within the topology, wherein the plurality of UEs are initialized in locations in the topology and the UE locations are updated each timestep of a plurality of timesteps of the simulation according to the mobility pattern.

Step s908 of the method includes computing, at a first timestep of the simulation, a respective action for each network node of the plurality of network nodes according to a policy.

Step s910 of the method includes computing, for each network node of the plurality of network nodes, a reward value based on the mobility pattern and the respective action for each network node.

Step s912 of the method includes updating the policy based on the reward value.

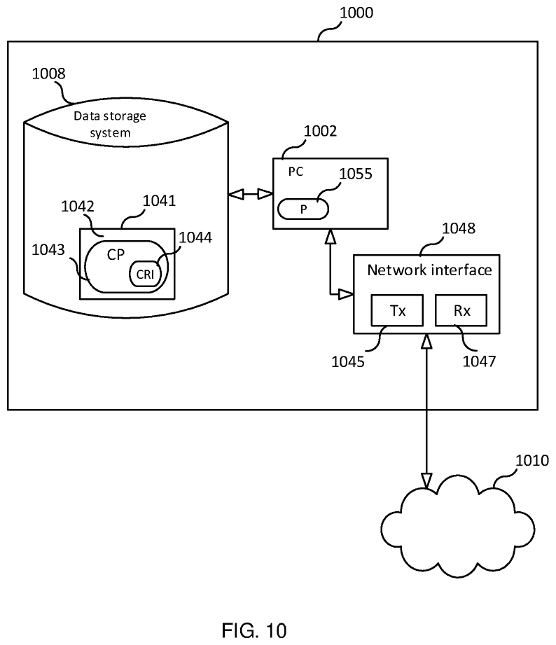

FIG. 10 is a block diagram of a computing device 1000 according to some embodiments. In some embodiments, computing device 1000 may comprise one or more of the components of a network node or agent. As shown in FIG. 10, the device may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like); communication circuitry 1048, comprising a transmitter (Tx) 1045 and a receiver (Rx) 1047 for enabling the device to transmit data and receive data (e.g., wirelessly transmit/receive data) over network 1010; and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes the apparatus to perform steps described herein (e.g., steps described herein with reference to the flow charts). In other embodiments, the apparatus may be configured to perform steps described herein without the need for code. That is, for example, PC 1002 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] PCT/IB2020/061668, “Decentralized coordinated reinforcement learning for optimizing radio access networks,” filed on Dec. 9, 2020.
[2] Xie, Bin, Anup Kumar, Dave Cavalcanti, Dharma P. Agrawal, and S. Srinivasan. “Mobility and routing management for heterogeneous multi-hop wireless networks.” In IEEE International Conference on Mobile Adhoc and Sensor Systems Conference, 2005., pp. 7-pp. IEEE, 2005.
[3] 3. G. P. Project, Study on the Self-Organizing Networks (SON) for 5G networks (Release 16), 2019.
[4] Eckhardt, Harald, Siegfried Klein, and Markus Gruber. “Vertical antenna tilt optimization for LTE base stations.” In 2011 IEEE 73rd Vehicular Technology Conference (VTC Spring), pp. 1-5. IEEE, 2011.
[5] Eisenblatter, Andreas, and Hans-Florian Geerdes. “Capacity optimization for UMTS: Bounds and benchmarks for interference reduction.” In 2008 IEEE 19th International Symposium on Personal, Indoor and Mobile Radio Communications, pp. 1-6. IEEE, 2008.
[6] Saeed, Arsalan, Osianoh Glenn Aliu, and Muhammad Ali Imran. “Controlling self healing cellular networks using fuzzy logic.” In 2012 IEEE Wireless Communications and Networking Conference (WCNC), pp. 3080-3084. IEEE, 2012.
[7] Partov, Bahar, Douglas J. Leith, and Rouzbeh Razavi. “Utility fair optimization of antenna tilt angles in LTE networks.” IEEE/ACM Transactions On Networking 23, no. 1 (2014): 175-185.
[8] Farooq, Hasan, Ali Imran, and Mona Jaber. “Ai empowered smart user association in lte relays hetnets.” In 2019 IEEE International Conference on Communications Workshops (ICC Workshops), pp. 1-6. IEEE, 2019.
[9] Dandanov, Nikolay, Hussein Al-Shatri, Anja Klein, and Vladimir Poulkov. “Dynamic self-optimization of the antenna tilt for best trade-off between coverage and capacity in mobile networks.” Wireless Personal Communications 92, no. 1 (2017): 251-278.
[10] Balevi, Eren, and Jeffrey G. Andrews. “Online antenna tuning in heterogeneous cellular networks with deep reinforcement learning.” IEEE Transactions on Cognitive Communications and Networking 5, no. 4 (2019): 1113-1124.
[11] Shafin, Rubayet, Hao Chen, Young-Han Nam, Sooyoung Hur, Jeongho Park, Jianzhong Zhang, Jeffrey H. Reed, and Lingjia Liu. “Self-tuning sectorization: Deep reinforcement learning meets broadcast beam optimization.” IEEE Transactions on Wireless Communications 19, no. 6 (2020): 4038-4053.
[12] Galindo-Serrano, Ana, and Lorenza Giupponi. “Distributed Q-learning for aggregated interference control in cognitive radio networks.” IEEE Transactions on Vehicular Technology 59, no. 4 (2010): 1823-1834.
[13] Vannella, Filippo, Jaeseong Jeong, and Alexandre Proutiere. “Off-policy Learning for Remote Electrical Tilt Optimization.” In 2020 IEEE 92nd Vehicular Technology Conference (VTC2020-Fall), pp. 1-5. IEEE, 2020.
[14] Guo, Weisi, Siyi Wang, Yue Wu, Jonathan Rigelsford, Xiaoli Chu, and Tim O'Farrell. “Spectral- and energy-efficient antenna tilting in a HetNet using reinforcement learning.” In 2013 IEEE Wireless Communications and Networking Conference (WCNC), pp. 767-772. IEEE, 2013.
[15] Ariyakhajorn, Jinthana, Pattana Wannawilai, and Chanboon Sathitwiriyawong. “A comparative study of random waypoint and gauss-markov mobility models in the performance evaluation of manet.” In 2006 International Symposium on Communications and Information Technologies, pp. 894-899. IEEE, 2006.
[16] Wang, Dongyu, Xinqiao Tian, Haoran Cui, and Zhaolin Liu. “Reinforcement learning-based joint task offloading and migration schemes optimization in mobility-aware MEC network.” China Communications 17, no. 8 (2020): 31-44.
[17] Sliwa, Benjamin, and Christian Wietfeld. “Data-driven network simulation for performance analysis of anticipatory vehicular communication systems.” IEEE Access 7 (2019): 172638-172653.
[18] Xie, Bin, Anup Kumar, Dave Cavalcanti, Dharma P. Agrawal, and S. Srinivasan. “Mobility and routing management for heterogeneous multi-hop wireless networks.” In IEEE International Conference on Mobile Adhoc and Sensor Systems Conference, 2005., pp. 7-pp. IEEE, 2005.
[19] Guestrin, Carlos, Michail Lagoudakis, and Ronald Parr. “Coordinated reinforcement learning.” In ICML, vol. 2, pp. 227-234. 2002.
[20] Lillicrap, Timothy P., Jonathan J. Hunt, Alexander Pritzel, Nicolas Heess, Tom Erez, Yuval Tassa, David Silver, and Daan Wierstra. “Continuous control with deep reinforcement learning.” arXiv preprint arXiv: 1509.02971 (2015).

### ABBREVIATIONS

RL Reinforcement Learning
UE User Equipment
CIO Cell Individual Offset
SINR Signal to Interference plus Noise Ratio
KPI Key Performance Indicator
DDPG Deep Deterministic Policy Gradient
BS Base Station
QoE Quality of Experience
SON Self Organizing Network
MDP Markov Decision Process

1. A computer-implemented method for optimizing resources in a radio access network based on mobility, the method comprising:
obtaining a topology of a radio access network, the topology comprising a plurality of network nodes serving one or more cells;
obtaining a mobility pattern of a plurality of user equipment;
initializing a simulation of movement of the plurality of UEs within the topology, wherein the plurality of UEs are initialized in locations in the topology and the UE locations are updated each timestep of a plurality of timesteps of the simulation according to the mobility pattern;
computing, at a first timestep of the simulation, a respective action for each network node of the plurality of network nodes according to a policy;
computing, for each network node of the plurality of network nodes, a reward value based on the mobility pattern and the respective action for each network node; and
updating the policy based on the reward value.

2. The method of claim 1, further comprising:
assigning, at the first timestep of the simulation, a set of one or more coordinates of the topology as a hot zone based on the mobility pattern.

3. The method of claim 1, further comprising:
selecting a set of UEs from the plurality of UEs; and
calculating, at the first timestep of the simulation, one or more key performance indicator (KPI) of each UE in the set of UEs, wherein the KPI is at least one of: signal to interference plus noise ratio (SINR), throughput, or power consumption.

4. (canceled)

5. The method of claim 1, wherein the mobility pattern comprises a mobility model comprising Working Professional, Random Waypoint, Gaussian Markov, a custom mobility pattern, or a combination thereof.

6. The method of claim 5, wherein the Working Professional mobility model simulates an individual movement pattern of a UE belonging to a commuting professional who moves between an office and a home location during one or more intervals of time.

7. The method of claim 5, wherein the Random Waypoint mobility model creates random movement simulation for each UE and how the UE's location, velocity, or acceleration changes over time.

8. The method of claim 5, wherein the Gaussian Markov mobility model creates movement across the topology where a UE's next transition point depends on the UE's speed or direction at a current timestep.

9. (canceled)

10. The method of claim 5, wherein the custom mobility pattern model comprises a dataset comprising a UE's trajectories at a regular interval or a mobility model that takes as input a set of user locations in the topology at an initial timestep and outputs a second set of user locations in the topology at a next timestep.

11. The method of claim 1, wherein the computing, at the first timestep of the simulation, the respective action for each network node of the plurality of network nodes comprises calculating
aᵢ=μ(sᵢ;θ)
for all network nodes i, where aᵢ is the action of network node i, μ is the policy, sᵢ is a mobility state at a timestep in the simulation, and θ represents parameters of a learned policy, wherein θ represents a set of one or more weights for a neural network.

12. (canceled)

13. The method of claim 1, wherein the reward value R(s,a,s′) is computing according to
R(s,a,s′)=R_{static}(a,s′)+WR_{mobility}(s,a,s′)
wherein s is a mobility state at a current timestep of the simulation, a is the computed action, and s′ is a mobility state at a next timestep of the simulation,
R_{static} is a reward for a static network performance,
w is a weight, and
R_{mobility} is a reward for a mobility network performance corresponding to state s at a current timestep of the simulation, action a, and state s′ at a next timestep of the simulation.

14. The method of claim 13, wherein R_{mobility} corresponds to a reward proportional to an average throughput, a signal to interference plus noise ratio (SINR) fairness, an edge SINR, a power consumption, a UE flow, or a combination thereof.

15. The method of claim 14, wherein the average throughput comprises at least one of an average of each UE throughput in a sector of each network node or a normalization of the average of each UE throughput by subtracting a mean throughput and dividing by a maximum throughput.

16. (canceled)

17. (canceled)

18. The method of claim 14, wherein the edge SINR is proportional to a cell-edge UE SINR comprising a bottom 5% of SINR values.

19. The method of claim 14, wherein the power consumption is a penalization corresponding to a total transmit power over an average UE throughput per a cell sector.

20. (canceled)

21. The method of claim 13, wherein R_{mobility} is a penalization having a negative value.

22. The method of claim 1, wherein the policy comprises a reinforcement learning (RL) model.

23. The method of claim 1, wherein the topology comprises a Cartesian plane having a boundary, and coordinates of each network node and their respective cell identifier(s) are plotted in the Cartesian plane.

24. The method of claim 1, wherein the action comprises a tilt of an antenna of each respective network node.

25. A device for optimizing resources in a radio access network based on mobility, wherein the device comprises a processor and a memory, and wherein the device is adapted to:
obtain a topology of a radio access network (RAN), the topology comprising a plurality of network nodes serving one or more cells;
obtain a mobility pattern of a plurality of user equipment (UEs);
initialize a simulation of movement of the plurality of UEs within the topology, wherein the plurality of UEs are initialized in locations in the topology and the UE locations are updated each timestep of a plurality of timesteps of the simulation according to the mobility pattern;
compute, at a first timestep of the simulation, a respective action for each network node of the plurality of network nodes according to a policy;
compute, for each network node of the plurality of network nodes, a reward value based on the mobility pattern and the respective action for each network node; and
update the policy based on the reward value.

26. A computer program comprising instructions which when executed by processing circuitry of a computing device cause the device to:
obtain a topology of a radio access network (RAN), the topology comprising a plurality of network nodes serving one or more cells;
obtain a mobility pattern of a plurality of user equipment (UEs);
initialize a simulation of movement of the plurality of UEs within the topology, wherein the plurality of UEs are initialized in locations in the topology and the UE locations are updated each timestep of a plurality of timesteps of the simulation according to the mobility pattern;
compute, at a first timestep of the simulation, a respective action for each network node of the plurality of network nodes according to a policy;
compute, for each network node of the plurality of network nodes, a reward value based on the mobility pattern and the respective action for each network node; and
update the policy based on the reward value.

27. (canceled)
